(19) United States
(12) Patent Application Publication
(10) Pub. No.: US 2013/0156881 A1
(43) Pub. Date: Jun. 20, 2013

(54) Knockout Plunger for Patty-Forming Machine

(71) Applicant: FORMAX, INC. AN ILLINOIS CORPORATION, Mokena, IL (US)

(72) Inventor: Douglas Conerton, Bourbonnais, IL (US)

(73) Assignee: FORMAX, INC. AN ILLINOIS CORPORATION, Mokena, IL (US)

(21) Appl. No.: 13/689,357

(22) Filed: Nov. 29, 2012

Related U.S. Application Data
(60) Provisional application No. 61/564,702, filed on Nov. 29, 2011.

(51) Int. Cl. A22C 7/00

(52) U.S. Cl. CPC A22C 7/0038
USPC 425/444

(57) ABSTRACT

A patty-displacing end portion is provided for a plunger for a food patty-molding apparatus, the apparatus comprising an apparatus frame, a mold plate, the plunger and a heating element. The mold plate has at least one cavity and is mounted to move with respect to the frame in a direction to position the cavity between a fill position wherein the cavity is filled with food product material to form a molded patty, and a molded patty knockout position. The plunger is arranged to move vertically into the cavity to dislodge or knock the olded patty out of the cavity. The plunger has a body and raised formations or standoffs extending down from the body, the raised formations being numbered and positioned to be spread out over the body. The number and position of the raised formations provides a decreased contact pressure on the patty being dislodged.

This application claims the benefit of U.S. Provisional Application No. 61/564,702, filed Nov. 29, 2011.

### TECHNICAL FIELD OF THE INVENTION

The present invention relates to food patty-molding machines. The invention particularly relates to food patty-molding machines which incorporate a moving old plate having one or more patty-forming cavities which are filled to form patties, and then emptied by action of one or more knockout plungers, the patties being discharged to a patty-receiving area.

### BACKGROUND OF THE INVENTION

Food patty-forming or molding machines are described, for example, in U.S. Pat. Nos. 7,255,554; 8,011,914; 6,454,559; 6,368,092; 3,887,964; 4,372,008 and 4,821,376. A known food patty-forming machine or apparatus 20 is illustrated in FIG. 1. This machine is described in detail in U.S. Pat. No. 3,887,964 and has been marketed as the FORMAX F-26 machine by Formax, Inc., of Mokena, Ill. Molding machine 20 includes a machine base 21 which supports the operating mechanisms of the machine and contains hydraulic actuating systems, electrical actuating systems, and most of the machine controls.

The food patty-molding machine 20 includes a supply mechanism 24 for storing and supplying a moldable food product_{;} such as ground beef, fish, pork_{;} chicken, potatoes, or the like, to the processing mechanisms of the machine. Supply mechanism 24 includes a large food product storage hopper 25 that supplies a food pump system 26. System 26 includes two alternately operating food pumps (one shown); other machines typically include only a single food pump. The two food pumps continuously pump food, under pressure, into a valve manifold connected to a cyclically operable molding station 28. Molding station 28 includes a multi-cavity mold plate 32 that moves cyclically between a fill position, as shown in FIG. 1, and a discharge position ire which its mold cavities are outside of station 28, aligned with a set of plungers having patty-displacing end portions in the form of knockout cups 33. The cups are sized and shaped to be slightly smaller than, but to closely conform to, the cavities in the mold plate.

Food supply mechanism 24 includes a conveyor belt 31 that extends completely is across the bottom of hopper 25. In FIG. 1, a limited supply of food product 38 is shown in hopper 25; a much greater supply could be stored in the hopper without exceeding its capacity. The forward end of hopper 25 communicates with a vertical hopper outlet 39 that leads downwardly into two pump chambers; only one pump chamber 69 is shown. Three motors drive three vertical feed screws. Only one motor 47 and one feed screw 3 are shown in FIG. 1.

The upper part of a pump housing 71 comprises a plate 81 that supports the mold plate 32. The mold plate 32 includes a plurality of individual mold cavities 86 distributed in a single row or multiple rows across the width of the mold plate; mold cavities 86 are alignable with the manifold outlet fill passage 79. A mold cover 82 is disposed immediately above mold plate 32, closing off the top of each of the mold cavities 86. The mold cover 82 may include a conventional breather plate. Suitable spacers (not shown) are provided to maintain the spacing between the cover 82 and the support plate 81, essentially equal to the thickness of the mold plate 32. A housing 88 is positioned over the cover plate 82. The housing 88 encloses the operating mechanism (not shown) for reciprocating the knockout cups 33.

In the operation of the patty-molding machine 20, a supply of ground meat or other moldable food product 38 is placed into the hopper 25, and is advanced toward the hopper outlet 39 by the conveyor 31. Whenever one of the food pump plungers, such as the plunger 68, is retracted to expose a pump cavity (e.g., the cavity 69), the vertical feed screws 53 aligned with that pump cavity are actuated to feed the food product into the pump cavity.

In FIG. 1, pumping system 26 is illustrated with the mold plate 32 in its fill position, and with the pump 61 pumping the moldable food product through the manifold 27. The pump 61, as shown, has just begun its pumping stroke, and has compressed the food product in pump cavity 69, forcing it under pressure into the manifold 27. As operation of the machine 20 continues, the plunger 68 advances and food product flows into the mold cavities 126, there is a relatively constant pressure on the food product and chamber 69, manifold 27, fill passage 79, and cavities 86.

In each molding cycle, mold plate 32 remains in this fill position for a limited dwell interval. As the mold cavities 86 move into the fill position, one of the two food pumps of machine 20 pumps food product through manifold 27 and fill passage 79, filling the mold cavities. To assure complete filling of the mold cavities, the food pump must apply a substantial pressure to the food product.

Following the fill dwell interval, mold plate 32 is moved outwardly, to the right from its fill position, as shown in FIG. 1, until it reaches a discharge position with its mold cavities 86 aligned with knockout cups 33. As mold plate 32 moves toward its discharge position, mold cavities 86 all move dear of fill passage 79 before any part of those cavities projects out of mold station 28, beyond support plate 81 and cover 82. Thus, the food pump in machine 20, as shown in FIG. 1, remains sealed off at all times. A second dwell interval occurs at the discharge position of mold plate 32, during which knockout cups 33 move downwardly through the mold cavities, discharging the molded food patties onto a patty-receiving area, e.g. a take-off conveyor (not shown).

The knock out cups are typically concave cups each having a surrounding edge, typically 3/32 inch thick, which presses on an outside circular perimeter of the patty to dislodge the patty from the mold plate.

Following discharge of the molded food patties, mold plate 32 is moved back toward its fill position so that mold cavities 86 can again be filled with food product. Again, mold cavities 86 are completely inside molding mechanism 28, sealed off, before they come into alignment with the fill passage 79.

For some food products a radiant heating element (not shown in FIG. 1) is used to heat the knockout cups 33 to an elevated temperature of between 180-210° F. in order to liquefy the fat in the food product, thereby facilitating release of patties from the cups at the bottom of knockout cup travel.

The present inventors have recognized that on occasion, depending on the product, the perimeter of the heretofore known knockout cup can cause an indentation on the perimeter of the patty which is visible after cooking. The present inventors have recognized that it would be desirable to provide a knockout plunger for a patty-forming apparatus that did not cause a visible irregularity in cooked patties. The present inventors have recognized that it would be desirable to provide a knockout cup for a patty-forming apparatus that was cost effectively produced and that would be durable in operation.

### SUMMARY OF THE INVENTION

The present invention provides an improved plunger for a food patty-forming apparatus having a mold plate with mold cavities adapted to be filled with food product to form patties, wherein the patties are removed from the cavities by action of the plunger. Preferably, the patty-displacing end portion has a perimeter that closely matches an inside perimeter of the cavity. The improved plunger includes plural, spaced-apart raised portions or standoffs on a bottom surface thereof that press on a top surface of the patty to dislodge the patty from a mold plate.

The standoffs have sufficient surface area to minimize surface pressure on the patty to avoid indentations or alternately, leave spaced-apart isolated indentations that visually blend into the typical irregular texture of the patty product.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a diagrammatic sectional view of a prior art food patty-molding machine;

FIG. 2 is a diagrammatic fragmentary perspective view of a portion of a food patty forming machine incorporating the improvement of the present invention;

FIG. 3 is a diagrammatic sectional view of a food patty-forming apparatus according to the present invention, with the apparatus mold plate in a knockout position; and

FIG. 4 is a bottom perspective view of a plunger taken from FIG. 3.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

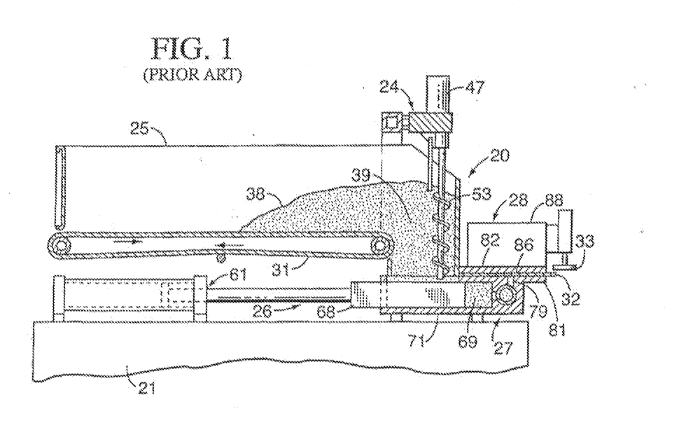

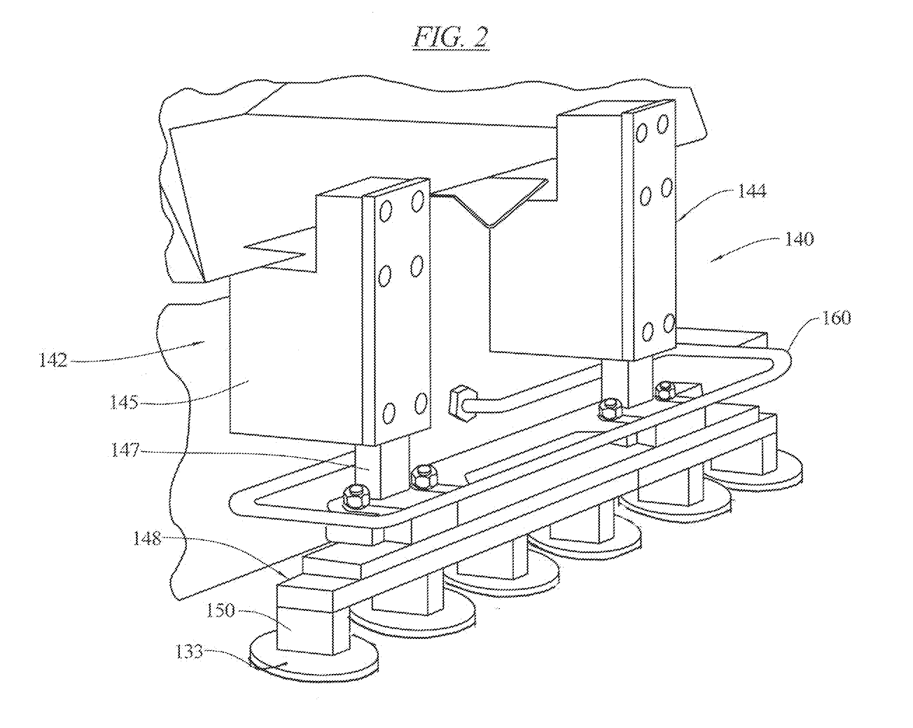

FIG. 2 illustrates a modified food patty-forming apparatus 120 of the present invention. Except as otherwise described herein, the apparatus 120 can be of a reciprocating type such as described in U.S. Pat. Nos. 7,255,554; 8,011,914; 6,454,559; 6,368,092; 3,887,964; 4,372,008 and 4,821,376, herein incorporated by reference, or a rotary type as described in U.S. Ser. No. 13/187,426, filed Jul. 20, 2011. Like components compared to the components of the prior art apparatus of FIG. 1 carry like reference numerals.

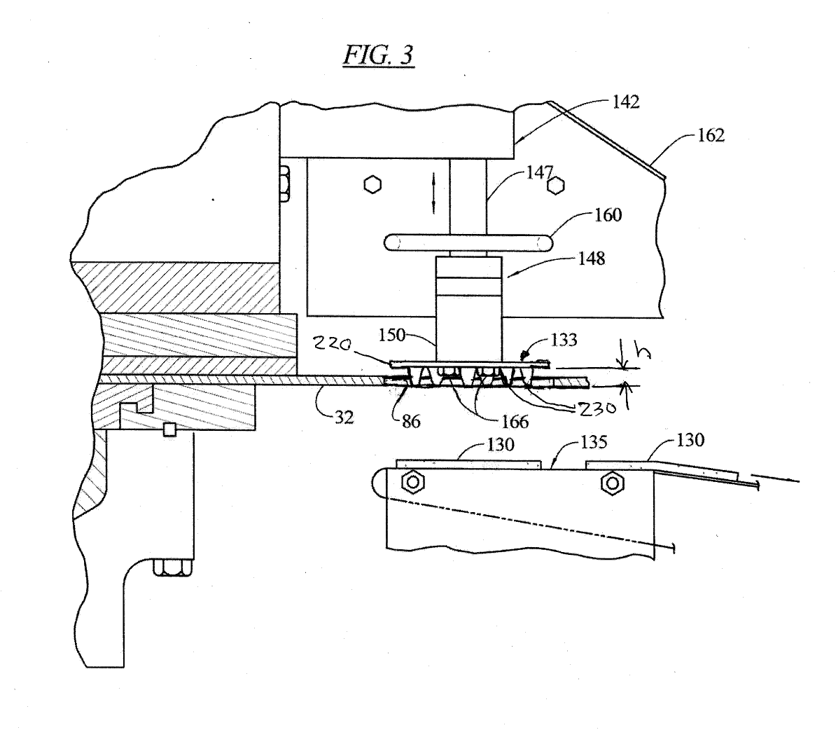

The apparatus 120 includes a mold plate 32 that moves cyclically between a fill position as shown in FIG. 1 and a discharge or knockout position as shown in FIG. 3. In the discharge position, a row of food patties 130 which occupy mold cavities 86 within the mold plate 32, are discharged by downward movement of a row of knockout plungers 133. The food patties 130 can be delivered to a take-off conveyor 135 such as shown in FIG. 3.

FIG. 2 illustrates a knockout mechanism 140 that includes two knockout drive units 142, 144. The drive units 142, 144 can be configured in various known fashions such as those described in U.S. Pat. Nos. 7,255,554; 8,011,914; 6,368,092; 4,768,260; or 3,887,964, or U.S. Ser. No. 13/187,426, filed Jul. 20, 2011, all herein incorporated by reference. Each drive unit 142, 144 can include a rod housing 145 within which a reciprocating knockout rod 147 is at least partially enclosed. Each knockout rod 147 can be fastened to a knockout bar assembly 148.

A plurality of knockout support blocks 150 are mounted to a bottom side of the bar assembly 148 spaced apart along a length of the bar assembly. Each block 150 mounts one of the plurality of the knockout plungers 133. The number and spacing of knockout plungers 133 corresponds to the number and location of the plurality of the cavities 86, that are arranged in rows across a width of the mold plate 32.

A radiant electric heater 160 circumscribes the two knockout rods 147 and is located at an elevation approximately equal to the bar assembly 148 when fully elevated at the top of its reciprocating stroke. A heat deflector shield or hood 162 (shown in fragmentary fashion in FIG. 3) directs heat from the heater 160 to the plungers 133. The heater 160 is configured to heat the knockout plungers to an operating temperature of 180-210° F. depending on the food material being formed in order to assist in dislodging of the patties from the mold plate and to prevent sticking to the plungers. A rheostat (not shown) is wired to the heater element 160 to manually set the temperature of the plungers 133. A more sophisticated control system using a temperature sensor and an automatic adjustment can also be used.

FIG. 3 illustrates the apparatus 120 with the mold plate 32 in the discharge or knockout stage or position. The knockout plungers 133 are shown in a downward position, having just discharged patties 130 from cavities 86 respectively. The patties 130 can be deposited on the product conveyor 135 to move to a collection area for packaging.

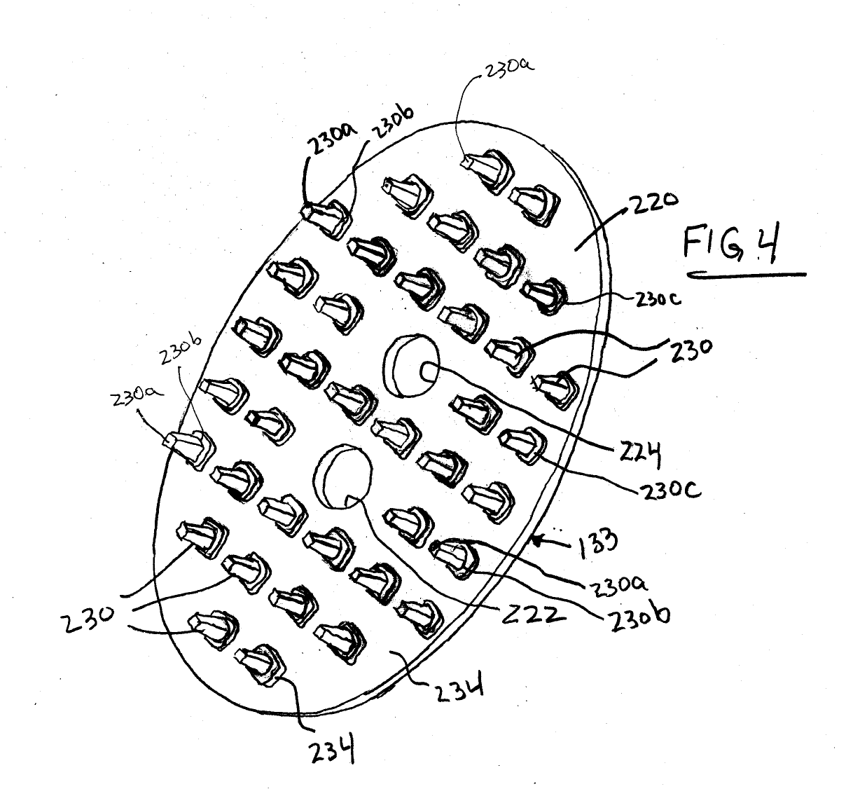

FIGS. 3 and 4 illustrate the configuration of the plungers 133. According to one embodiment of the invention, the plunger 133 can be composed of aluminum with a USDA compliant coating, or acetyl copolymer or stainless steel. The acetyl does not need a coating. The stainless steel version could be used with or without a coating. The plunger 133 includes a plunger body 220. Each plunger 133 can be fastened to the respective support block 150 using a pair of fasteners 166 that are inserted through holes 222, 224 through the body 220.

The size and shape of the plunger body 220 is in direct relation to the patty size. Depending on the size of the product to be knocked out, the plunger body 220 could be as small as 2 inches in diameter or as large as 4 inches by 6 inches. A circular disc shaped plunger body 220 is shown in the figures.

A plurality of raised formations, such as pins or standoffs 230 extend downwardly from a bottom surface 234 of the body 220. Each raised formations or standoff 230 has a flat distal surface 230a. According to the illustrated embodiment, each raised formation 230 is in the form of a tapered post or pin that is tapered from a base end 230b on the body 220 to the distal end 230a. The base end 230b can be mounted on, formed with, or connected to_{;} a reinforcing pad 230c on the bottom surface 234 of the body. During knockout of a product from the mold plate, the body is moved downward to the mold cavity and the flat distal surfaces 230a of the plural standoffs 230 push the patty from the mold plate. The raised formations or standoffs 230 are numbered such that the aggregate surface area of the distal surfaces 230a decreases the contact pressure by any one of the standoffs 230 during pressing of a patty to dislodge the patty from the mold plate. Additionally, the number and spacing of the standoffs 230 over the surface of the body 220 are such that any surface mark caused by the standoffs on the patty being dislodged will be hardly noticeable given the typical irregular texture of the patty material.

Traditional cups impact the product just inside of the mold cavity edges around the entire perimeter of the cavity. Since products are typically softer around the edges, the knockout cups can leave an impression in the product due to the force of the impact. The impact impression can be unattractive to some customers. By using spaced-apart standoffs 230 the knockout force is dispersed throughout more of the product top surface. In some applications, the standoffs can be spaced inward from the perimeter of the product to be knocked out by 1/16 inch or greater to prevent damage to the softer surrounding edge of the product to be knocked out. Also, traditional cup-shaped knockout cups, with contact only around the perimeter of the portion to be knocked out, allow the center of the portion being knocked out to bulge up into the empty center space of the knockout cup, causing negative effects such as stretching and/or cracking, especially on thin portions. The standoff locations inward of the perimeter of the knockout cup could prevent this bulging effect, allowing the patty to remain flatter throughout the knockout process. Although a flat disc shaped body 220 is shown, the standoffs 230 may also be used together with the existing ::perimeter“” or cup design to provide effective knockout with minimal portion marking and/or distortion. According to this design, multiple standoffs within the traditional knockout cup, and the perimeter of the knockout cup both knock out the product.

The number of standoffs 230 would be determined by multiple variables such as portion weight, portion thickness, product density and product texture. A minimum number of standoffs would be desired in order to minimize the contact area with the product yet provide effective knockout.

When the area of the bottom surface 234 is substantially equivalent to the top surface of the patty to be knocked out, an exemplary range of aggregate surface area of the distal surfaces 230a to the gross area of the bottom surface 234, which includes the area occupied by the pins 230 and pads 230c, can be between 1% and 10%. Stated another way, an exemplary range of aggregate surface area of the distal surfaces 230a to the area of a top surface of the patty to be knocked out, can be between 1% and 10%. The standoffs 230 can be spaced apart evenly on the bottom surface 234 or can be spaced apart unevenly depending on the product properties and test results. Advantageously, the height of the standoffs 230 on a given plunger are such that the distal surfaces 230a reside in a single plane, although the invention encompasses standoffs of varying heights and residing in multiple planes in a single plunger. Where the standoffs extend from a single planar bottom surface 234, an equal standoff height “h” defines a single plane for the distal surfaces 230a. According to exemplary embodiments, a height “h” of the single plane of the aggregate distal surfaces 230a of the standoffs 230 could vary between about 1/16 inch for some knockout applications to about 2 inches for other knockout applications. The reason for the height range is that the plunger body can act as a deflector, shielding the product to be knocked out from heat and moisture. In cases where this deflecting action is desired, very short standoffs would be used in order to get the plunger disc very dose to the product to be knocked out. In other cases where the deflecting action is not desired, longer standoffs can be used to move the plunger disc away from the surface of the product to be knocked out. According to exemplary embodiments, the number of standoffs can vary with an anticipated density of 1 to 10 standoffs per square inch of the top surface of the product to be knocked out.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. In a food-patty forming apparatus having a mold plate with mold cavities adapted to be filled with food product to form patties, wherein said patties are removed from the cavities by action of a plunger, the improvement comprising:
said plunger having a plunger surface with a plurality of spaced-apart raised formations for pressing a patty to be removed.

2. The improvement according to claim 1, wherein said plurality of spaced-apart raised formations are evenly spread out over a said surface.

3. The improvement according to claim 1, wherein plurality of spaced-apart raised formations each comprise a tapered post.

4. The improvement according to claim 3, comprising a heating element configured to heat said plunger to a temperature greater than ambient temperature.

5. The improvement according to claim 3, wherein said tapered posts each have a flat surface on a distal end.

6. The improvement according to claim 1, wherein the surface is sized and shaped to fit closely within a mod cavity for patty removal.

7. The improvement according to claim 1, wherein said raised formations are set in from a peripheral edge of a patty to be removed by the plunger.

8. The improvement according to claim 1, wherein the raised formations have an aggregate surface area that faces the patty to be removed by the plunger, the aggregate surface area pressing a top surface of the patty to be removed to remove the patty from the mold plate cavity, wherein the aggregate surface area comprises 1 to 10% of the area of the top surface of the patty to be removed.

9. The improvement according to claim 8, wherein the plunger surface comprises a flat plate.

10. The improvement according to claim 8, wherein the plunger surface comprises a portion of a cup shaped body having a concave shape facing the patty to be removed and having a perimeter that closely matches the shape of the mold cavity holding the patty.

11. The improvement according to claim 1, wherein the raised formations comprise standoffs having a length of between 1/16 inch to 2 inches.

12. A knock out plunger for a food-patty forming apparatus having a mold plate with mold cavities adapted to be filled with food product to form patties, wherein said patties are removed from the cavities by action of the plunger, comprising:
a body having a surface with a plurality of spaced-apart raised formations for pressing against the patty to be removed.

13. The plunger according to claim 12, wherein said plurality of spaced-apart raised formations are evenly spread out over a said flat surface.

14. The plunger according to claim 12, wherein plurality of spaced-apart raised formations each comprise a tapered post.

15. The plunger according to claim 14, comprising a heating element configured to heat said plunger to a temperature greater than ambient temperature.

16. The plunger according to claim 14, wherein said tapered posts each have a flat surface on a distal end.

17. The plunger according to claim 14, wherein the body is sized and shaped to fit closely within a mold cavity for patty removal.

18. The plunger according to claim 12, wherein the body is sized and shaped to fit closely within a mold cavity for patty removal.

19. The plunger according to claim 12, wherein said raised formations are set in from a peripheral edge of a patty to be removed by the plunger,

20. The improvement according to claim 12, wherein the raised formations have an aggregate surface area that faces the patty to be removed by the plunger, the aggregate surface area pressing a top surface of the patty to be removed to remove the patty from the mold plate cavity, wherein the aggregate surface area comprises 1 to 10% of the area of the top surface of the patty to be removed.

21. The improvement according to claim 12, wherein the plunger surface comprises a flat plate.

22. The improvement according to claim 12, wherein the plunger surface 1s comprises a portion of a cup shaped body having a concave shape facing the patty to be removed and having a perimeter that closely matches the shape of the mold cavity holding the patty.

23. The improvement according to claim 12, wherein the raised formations comprise standoffs having a length of between 1/16 inch to 2 inches.
